(19) United States
(12) Patent Application Publication
(10) Pub. No.: US 2008/0028292 A1
(43) Pub. Date: Jan. 31, 2008

(54) TECHNIQUES TO FACILITATE READING OF A DOCUMENT

(75) Inventors: Jamey Graham, Menlo Park, CA (US); Jonathan J. Hull, San Carlos, CA (US); David G. Stork, Portola Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ricoh Company, Ltd., Tokyo (JP)

(21) Appl. No.: 11/841,989

(22) Filed: Aug. 20, 2007

Related U.S. Application Data
(63) Continuation of application No. 09/636,039, filed on Aug. 9, 2000.
Application No. 09/636,039 is a continuation-in-part of application No. 08/995,616, filed on Dec. 22, 1997, now abandoned.

(51) Int. Cl. G06F 15/00

(52) U.S. Cl. 715/230

(57) ABSTRACT

An automatic reading assistance application for documents available in electronic form. Embodiments of the present invention help a reader to quickly find and assimilate information contained in a document. According to an embodiment, the present invention annotates portions of a document which are relevant to user-specified concepts. According to another embodiment, the present invention builds and displays a thumbnail image which displays the contents of the document in a continuous manner. In a specific embodiment, the annotations and the thumbnail image may be displayed using an Internet Explorer browser

### CROSS-REFERENCES TO RELATED APPLICATIONS

This application is a continuation of U.S. Non-Provisional patent application Ser. No. 09/636,039 filed Aug. 9, 2000, which is a continuation-in-part application of U.S. Non-Provisional patent application Ser. No. 08/995,616, filed Dec. 22, 1997 (CPA filed May 25, 2000), the entire contents of which are herein incorporated by reference for all purposes.

### COPYRIGHT NOTICE

A portion of the disclosure of this patent document contains material which is subject to copyright protection. The copyright owner has no objection to the xerographic reproduction by anyone of the patent document or the patent disclosure in exactly the form it appears in the U.S. Patent and Trademark Office patent file or records, but otherwise reserves all copyright rights whatsoever.

### BACKGROUND OF THE INVENTION

The present invention relates to display of electronic documents and more particularly to method and apparatus for augmenting electronic document display with features to enhance the experience of reading an electronic document on a display.

Increasingly, readers of documents are being called upon to assimilate vast quantities of information in a short period of time. To meet the demands placed upon them, readers find they must read documents “horizontally,” rather than “vertically,” i.e., they must scan, skim, and browse sections of interest in multiple documents rather than read and analyze a single document from beginning to end.

Documents are now more and more available in electronic form. Some documents are available electronically by virtue of their having been locally created using word processing software. Other electronic documents are accessible via the Internet. Yet others may become available in electronic form by virtue of being scanned in, copied, or faxed. See commonly assigned U.S. application Ser. No. 08/754,721, entitled AUTOMATIC AND TRANSPARENT DOCUMENT ARCHIVING, the contents of which are herein incorporated by reference.

However, the mere availability of documents in electronic form does not assist the reader in confronting the challenges of assimilating information quickly. Indeed, many time-challenged readers still prefer paper documents because of their portability and the ease of flipping through pages.

Certain tools exist to take advantage of the electronic form of documents to assist harried readers. Tools exist to search for documents both on the Internet and locally. However, once the document is identified and retrieved, further search capabilities are limited to keyword searching. Automatic summarization techniques have also been developed but have limitations in that they are not personalized. They summarize based on general features found in sentences.

What is needed is a document display system that helps the reader find as well as assimilate the information he or she wants more quickly. The document display system should be easily personalizable and flexible as well.

### SUMMARY OF THE INVENTION

The present invention provides techniques which help a reader to quickly find and assimilate information contained in a document. The present invention discusses techniques for annotating portions of the document which are relevant to user-specified concepts. The present invention also discusses techniques for building and displaying a thumbnail image which displays the contents of the document in a continuous manner.

According to an embodiment, the present invention searches a document to locate text patterns in the document which are relevant to one or more user-specified concepts. The present invention marks the locations of the text patterns in the document. When the document is displayed to the user, the text patterns located in the document are annotated. According to an embodiment of the present invention, the manner in which the annotations are displayed is user-configurable.

According to another embodiment, the present invention builds a thumbnail image which displays the contents of the document. The present invention builds the thumbnail image by determining information about the contents of the document, and configuring the thumbnail image based on the information. According to an embodiment, the present invention determines information for text entities, image elements, and form elements contained in the document. The thumbnail image is then displayed to the user. A section of the thumbnail image is emphasized corresponding to the section of the document displayed in a first viewing area of a display. According to an embodiment of the present invention, annotations added to the document are also displayed in the thumbnail image.

According to an embodiment of the present invention, an Internet Explorer browser provided by Microsoft Corp. is used to display the annotations and the thumbnail image to the user. According to this embodiment, the present invention uses information stored in a DOM tree representation of the document to add the annotations and to build the thumbnail image.

A further understanding of the nature and advantages of the present invention may be realized by reference to the remaining portions of the specification and the attached drawings.

### BRIEF DESCRIPTION OF THE DRAWINGS

FIG. 1 depicts a representative computer system suitable for implementing the present invention;

FIGS. 2A and 2B depict IE browser user interfaces for viewing a document that has been annotated in accordance with an embodiment of the present invention;

FIG. 3 depicts a portion of a representative Bayesian belief network which may be used to identify concept-relevant words/phrases in a document according to an embodiment of the present invention;

FIGS. 4A, 4B, and 4C depict user interfaces which allow users to define and change concepts according to embodiments of the present invention;

FIGS. 5A and 5B depicts user interfaces which allow a user to provide feedback according to an embodiment of the present invention;

FIG. 6 depicts processing performed by an IE browser for displaying a document to the user according to an embodiment of the present invention;

FIG. 7 depicts processing performed by an embodiment of the present invention for annotating a document and for configuring and displaying a thumbnail image;

FIG. 8 depicts a simplified flowchart showing processing performed by an embodiment of the present invention for adding annotations to a document;

FIG. 9 depicts a portion of a modified HTML document which has been processed in accordance with an embodiment of the present invention; and

FIG. 10 depicts a simplified flowchart showing processing performed by an embodiment of the present invention for building and displaying a thumbnail image.

### DESCRIPTION OF THE SPECIFIC EMBODIMENTS

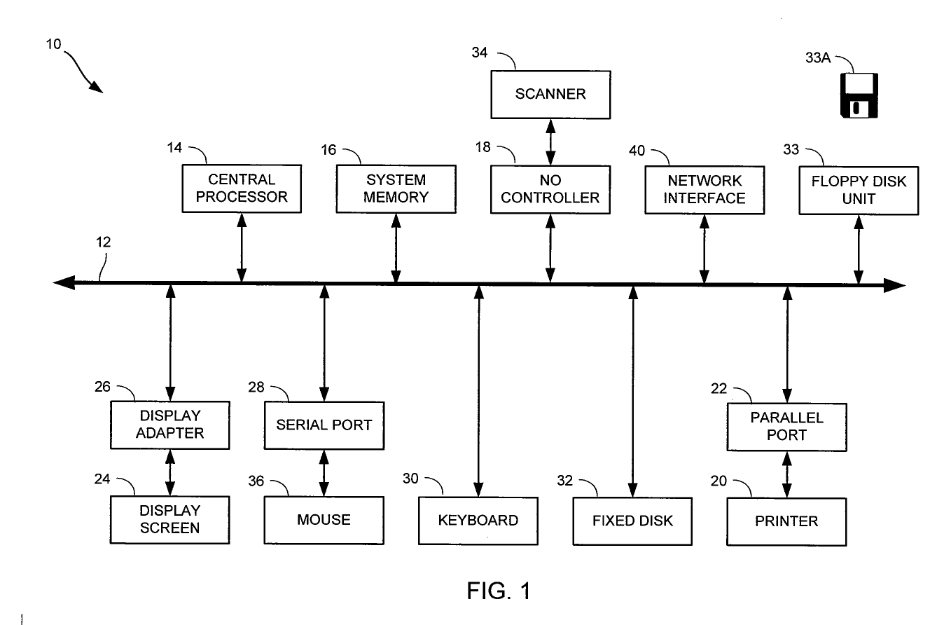

FIG. 1 depicts a representative computer system suitable for implementing the present invention. FIG. 1 shows basic subsystems of a computer system 10 suitable for use with the present invention. In FIG. 1, computer system 10 includes a bus 12 which interconnects major subsystems such as a central processor 14, a system memory 16, an input/output controller 18, an external device such as a printer 20 via a parallel port 22, a display screen 24 via a display adapter 26, a serial port 28, a keyboard 30, a fixed disk drive 32 and a floppy disk drive 33 operative to receive a floppy disk 33A. Many other devices may be connected such as a scanner 34 via I/O controller 18, a mouse 36 connected to serial port 28 or a network interface 40. Many other devices or subsystems (not shown) may be connected in a similar manner. Also, it is not necessary for all of the devices shown in FIG. 1 to be present to practice the present invention, as discussed below. The devices and subsystems may be interconnected in different ways from that shown in FIG. 1. The operation of a computer system such as that shown in FIG. 1 is readily known in the art and is not discussed in detail in the present application. Source code to implement the present invention may be operably disposed in system memory 16 or stored on storage media such as a fixed disk 32 or a floppy disk 33A. Image information may be stored on fixed disk 32.

Computer system 10 itself can be of varying types including a personal computer, a portable computer, a workstation, a computer terminal, a network computer, a television, a mainframe, or any other data processing system. Due to the ever-changing nature of computers, the description of computer system 10 depicted in FIG. 1 is intended only as a specific example for purposes of illustrating the preferred embodiment of the present invention. Many other configurations of a computer system are possible having more or less components than the computer system depicted in FIG. 1.

Further, the present invention may be embodied in a stand-alone computer system 10 or in a distributed computer environment wherein a plurality of computer systems are connected to a communication network. While in one embodiment, the communication network is the Internet, in other embodiments, the communication network may be any suitable computer network.

The present invention provides a personalizable system for automatically annotating documents to locate concepts of interest to a particular user. Various types of browsers may be used to view documents according to the teachings of the present invention. This application describes a specific embodiment of the present invention which uses an Internet Explorer browser (hereinafter referred to as the “IE browser”) provided by Microsoft Corporation of Redmond, Wash. to view the documents. It should however be apparent that other browsers may also be used to view documents according to the teachings of the present invention.

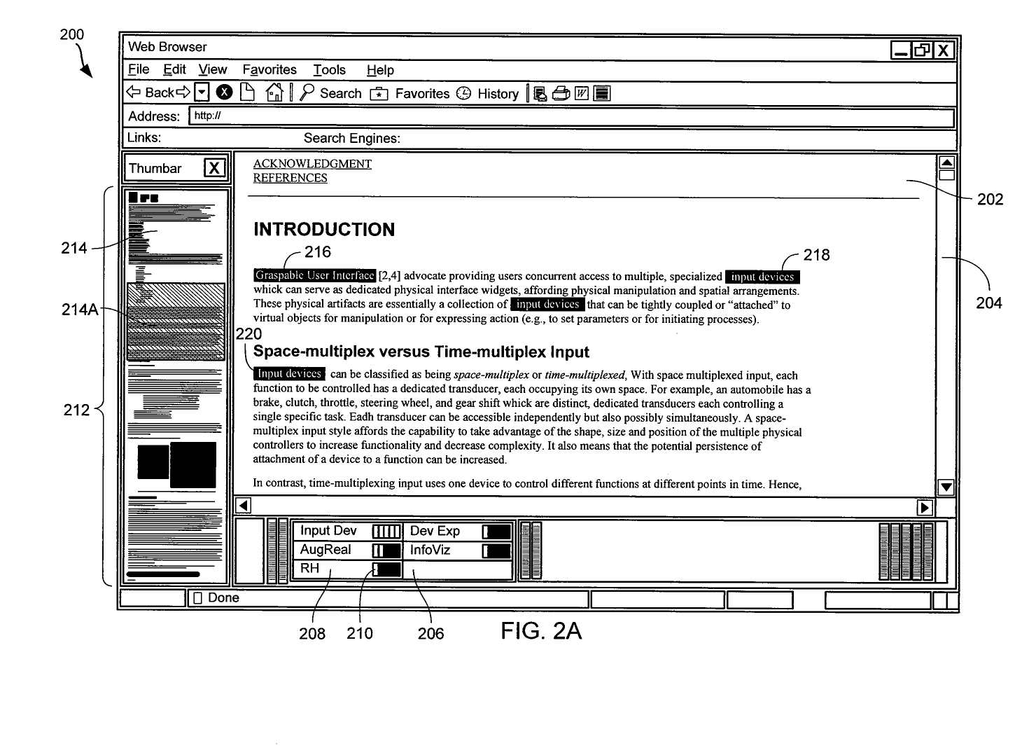

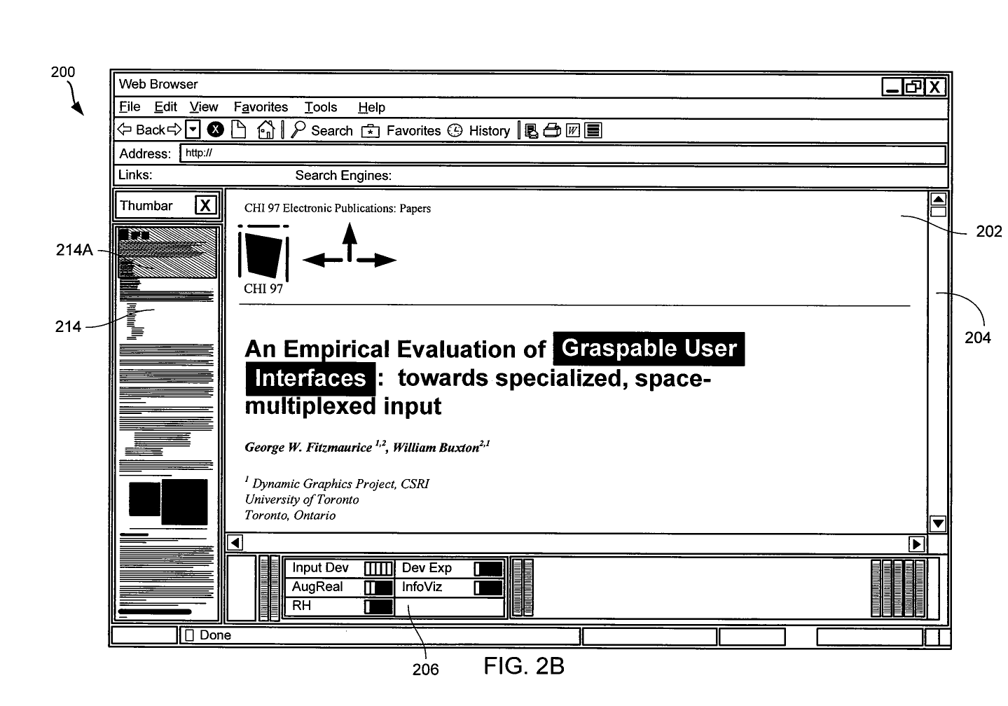

FIG. 2A depicts an IE browser user interface 200 for viewing a document that has been annotated in accordance with the present invention. According to the present invention, a first viewing area 202 shows a section of an electronic document along with the annotations for the document. A user may scroll through the electronic document using a scroll bar 204, or in other ways.

According to an embodiment of the present invention, user interface 200 also includes an area 206 which displays concepts of interest to the user. For example, in FIG. 2A, the user specified concepts include an “InputDev” concept, an “AugReal” concept, a “RH” concept, a “DevExp” concept, and an “InfoViz” concept. A user may specify a plurality of concepts. The user may then select one or more of the specified concepts which are to be noted for the presently displayed document (referred to as “concepts of interest to the user”). Area 206 displays the user-selected concepts. According to an embodiment, all the user-specified concepts may be displayed in area 206 in a default mode.

For each concept, a relevance indicator 210 is displayed indicating the relevance level of the currently viewed document to that concept. Various techniques may also be used to indicate the relevance of the document to the concepts. For example, in FIG. 2A, the relevance indicator uses a series of bars to indicate the relevance of the document to a concept. According to this embodiment, the relevance of the document to a particular concept is directly proportional to the number of bars displayed by the relevance indicator corresponding to the concept. For example, FIG. 2A indicates that the document (a section of which is displayed in first viewing area 202) is more relevant to the “InputDev” concept (which is indicated by 5 bars) than to the “InfoViz” concept (which is indicated by only 1 bar). In an alternate embodiment of the present invention, a percentage may be displayed for each concept indicating the relevance of the document to the concept. Please refer to parent application Ser. No. 08/995,616 for an interface wherein percentages are used to display the relevance level of the document. The relevance indicators thus offer a quick assessment of the relevance of the document to the various user-specified concepts.

According to the present invention, annotations may be added to the text displayed in first viewing area 202. The annotations denote text relevant to user-selected concepts. As will be explained further below, an automatic annotation system according to the present invention adds these annotations to any document available in electronic form. The document need not include any special information to assist in locating discussion of concepts of interest.

As shown in FIG. 2A, annotations in the form of highlights have been added in first viewing area 202. Phrases 216, 218, and 220 have been highlighted (or annotated) to indicate that they relate to concepts which are displayed in area 206. The highlighting is preferably in color. Each concept may have a particular color associated with the concept, and phrases/words relevant to the concept may be annotated using the color associated with that concept. For example, in FIG. 2A, a color “red” may be associated with the concept “InputDev” and a color “green” may be associated with the concept “AugReal.” If phrases 218 and 220 are related to the “InputDev” concept, then the phrases are highlighted in red. Similarly, if phrase 216 is related to concept “AugReal,” then phrase 216 is highlighted in green. However, for ease of illustration in black-and-white format, rectangles indicate the highlighted areas of text in FIG. 2A.

Various other techniques may also be used to indicate the annotations according to the teachings of the present invention. For example, the relevant text may be bolded, underlined, a marginal annotation in the form of a rectangular bar may indicate a paragraph that has been determined to have relevance above a predetermined threshold or to have more than a threshold number of key phrases, a balloon displaying information about a concept related to a phrase may appear when the phrase is selected using an input device such as a mouse, and other like techniques may be used to annotate the displayed document.

Interface 200 depicted in FIG. 2A also displays a thumbnail image 214 of the entire document in a second viewing area 212. The document displayed in first viewing area 202 may be a multi-page document with a section being displayed in first viewing area 202. Thumbnail image 214 displays a view of many pages, or of the entire document displayed in first viewing areas 202 in a continuous manner. As shown in FIGS. 2A and 2B, the actual contents of the document, including forms, text, images, etc. are displayed in thumbnail image 214. According to the teachings of the present invention, annotations incorporated into the document are also visible within elongated thumbnail image 214. Accordingly, elongated thumbnail image 214 provides a convenient view of the basic document structure making it easy to find relevant text anywhere in document. Furthermore, elongated thumbnail image 214 also provides a highly useful way of keeping track of one's position within a lengthy document. Additionally, since annotations are also displayed in thumbnail image 214, a user may very easily find areas of the document which are relevant to a particular concept.

Within elongated thumbnail image 214, an emphasized area 214A shows a reduced view of the document section currently displayed in first viewing area 202 with the reduction ratio preferably being user-configurable. Thus, if first viewing area 202 changes in size because of a change of window size, emphasized area 214A will also change in size accordingly. The greater the viewing area allocated to elongated thumbnail image 214 and emphasized area 214A, the more detail is visible. With very small allocated viewing areas, only sections of the document may be distinguishable. As the allocated area increases, individual lines and eventually individual words become distinguishable. The user-configured ratio depicted in FIG. 2A is approximately 7:1.

Emphasized viewing area 214A may be understood to be a lens or a viewing window over the part of elongated thumbnail image 214 corresponding to the document section displayed in first viewing area 202. A user may scroll through the document by sliding emphasized area 214A up and down. As emphasized area 214A shifts, the section of the document displayed in first viewing area 202 also shifts such that the section of the document emphasized by viewing area 214A is displayed in first viewing area 202. For example, as shown in FIG. 2B, emphasized area 214A has been shifted to the top of thumbnail image 214, and in response the section of the document displayed in first viewing area 202 has been automatically shifted to the top of the document to correspond to the emphasized area. Additionally, if a user scrolls through the document in first viewing area 202, for example by using scrollbar 204, emphasized area 214A will slide up or down thumbnail image 214 in response to the scrolling such that the section of thumbnail image 214 corresponding to the section of the document displayed in first viewing area 202 is emphasized.

As described above, the present invention annotates keywords and phrases in the document based on concepts specified by the user. Text patterns may be associated with each concept in order to characterize the concept. The present invention locates words/phrases and relevant discussion of concepts within the document based on the text patterns associated with the user specified concepts. In a specific embodiment, information associated with user specified concepts and their corresponding text patterns are stored in a user profile which is accessed by the present invention in order to facilitate annotation of the document. A profile editor may be provided to allow the user to add new concepts, modify information related to the concepts, or even delete concepts.

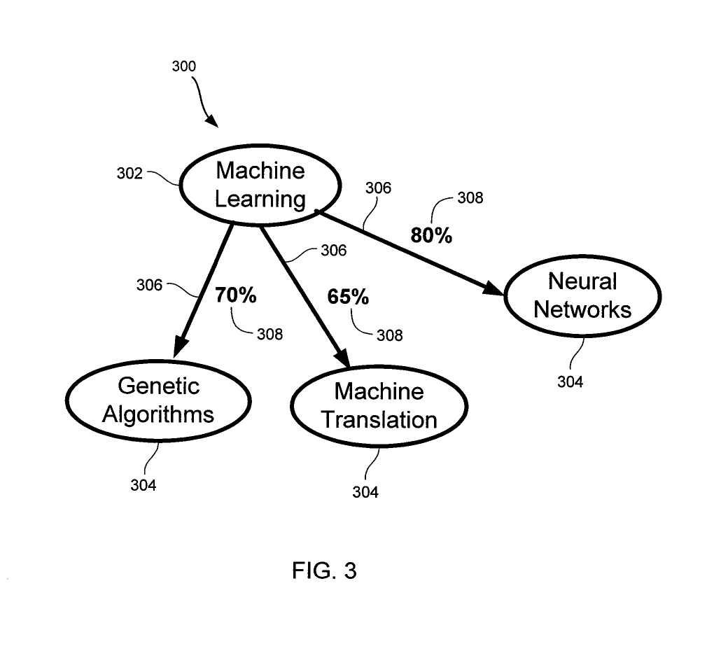

In a specific embodiment, the information stored in a user profile defines the structure of a Bayesian belief network which is used to identify words/phrases in the document which are relevant to user-specified concepts and which are to be annotated. FIG. 3 depicts a portion of a representative Bayesian belief network 300 implementing a belief system which may be used by the present invention to identify words/phrases in the document which are relevant to user-specified concepts. A first oval 302 represents a particular user-specified concept. Other ovals 304 represent sub-concepts related to the concept identified by oval 302. A line 306 between one of sub-concept ovals 304 and concept oval 302 indicates that discussion of the sub-concept implies discussion of the concept. Each connection between one of sub-concept ovals 304 and concept oval 302 may have an associated probability value 308 indicated in percent. For a given concept and its sub-concept, the probability value 308 indicates the probability that the concept indicated is discussed given the presence of evidence indicating the presence of the sub-concept. Discussion of the sub-concept may in turn be indicated by one or more keywords or key phrases (not shown in FIG. 3).

The structure of Bayesian belief network 300 is only one possible structure used in accordance with the present invention. For example, other Bayesian structures with more than two levels of hierarchy including sub-concepts, sub-sub-concepts, and so on may also be used. In a specific embodiment, presence of a keyword or key phrase always indicates presence of discussion of the concept or sub-concept. In alternate embodiments, the present invention may be configured such that presence of a keyword or key phrase suggests discussion of the concept or sub-concept with a specified probability.

As indicated above, the primary source for the structure of Bayesian belief network 300 including the selection of concepts, keywords and key phrases, interconnections, and probabilities is the user profile file. In a preferred embodiment, contents of a particular user profile may be shared between several users.

The structure of belief system 300 is also modifiable during use of the present invention. The modifications may occur automatically in the background or may involve explicit user feedback input. The present invention may monitor locations of concepts of interest within the document and modify the user profile based on the locations. For example, the present invention may note the proximity of other keywords and key phrases within each analyzed document to the locations of concepts of interest. If particular keywords and key phrases are always near a concept of interest, the structure and contents of belief system 300 may be updated in the background by the present invention without user input. This could mean changing probability values, introducing a new connection between a sub-concept and concept, introducing a new keyword or key phrase, and other like changes.

A user may also explicitly provide feedback by selecting a word or phrase in the document displayed in first viewing area 202 as being relevant to a particular concept even though the word or phrase has not yet been associated with the concept. Belief system 300 is then updated to include the new user-specified keyword or key phrase. A user may also give feedback for an existing key word or key phrase, indicating the perceived relevance of the keyword or key phrase to the concept of interest. If the selected keyword or key phrase is indicated to be of high relevance to the concept of interest, the probability values connecting the sub-concept indicated by the selected keywords or key phrases to the concept of interest may be increased. If, on the other hand, the user indicates the selected keywords or key phrases to be of little interest, the probability values connecting these keywords or key phrases to the concept may be decreased.

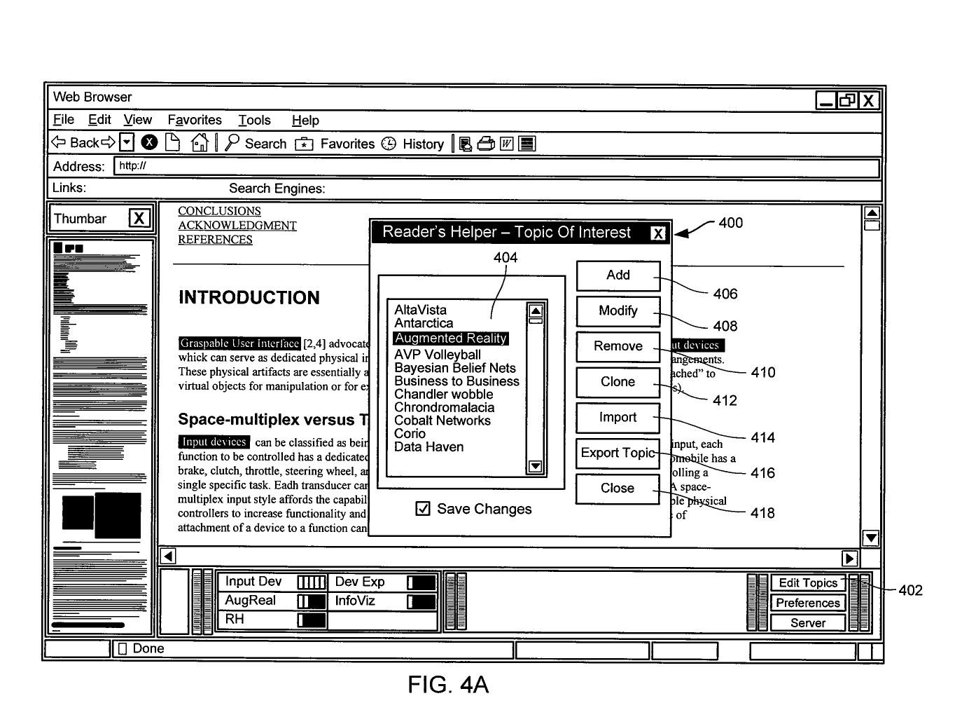

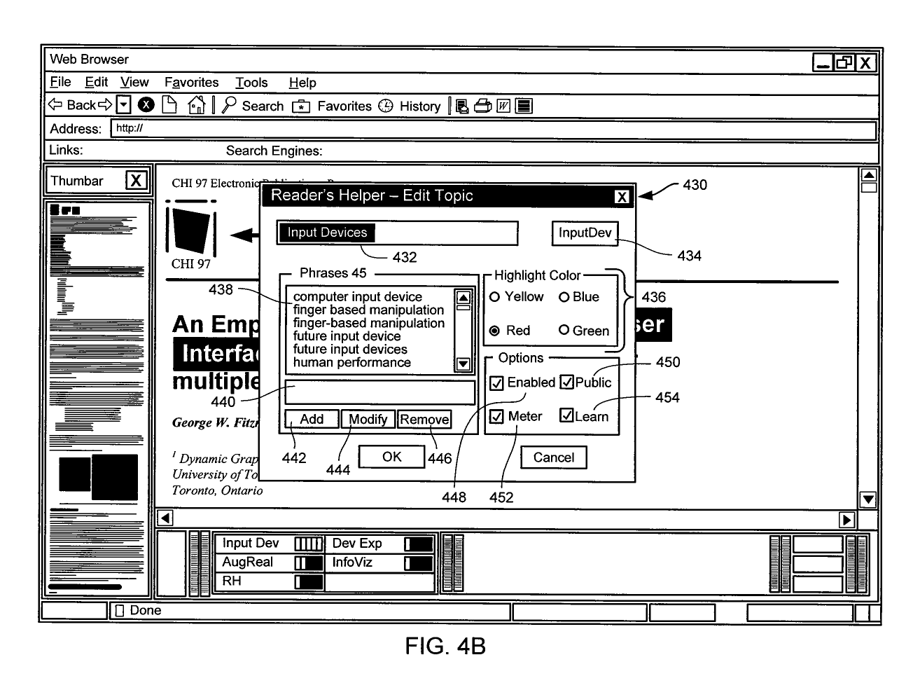

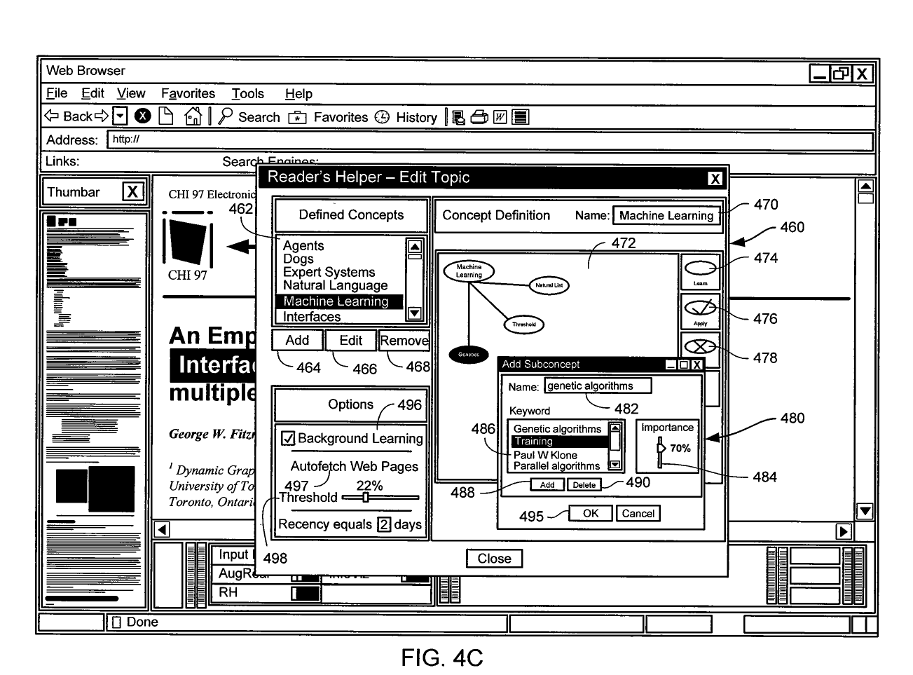

FIGS. 4A, 4B, and 4C depict exemplary user interfaces for defining concepts according to an embodiment of the present invention. FIG. 4A depicts a simplified user interface 400 which allows users to define and change concepts. In the embodiment depicted in FIG. 4A, user interface 400 may be invoked by selecting the “Edit Topics” button 402. It should be apparent that various other techniques may also be used to invoke user 400 such as by using an input device such as a keyboard, by selecting an option from the IE browser menu, and the like.

As shown, user interface 400 displays a list 404 of the various concepts defined by a user. The interface also provides various buttons which allow the user to manipulate the concepts. These buttons include an “Add” button 406 which facilitates the addition of new concepts, a “Modify” button 408 which facilitates the modification of existing concepts, a “Remove” button 410 which facilitates the deletion of concepts, a “Clone” button 412 which facilitates the copying of concepts, an “Import” button 414 which allows concepts to be imported from other applications or user profiles, and an “Export Topic” button 416 which allows the concepts to be exported to other applications. Other buttons for manipulating the concepts may also be provided. “Close” button 416 closes user interface 400.

A user may select a concept from list 404 and then select a button to perform an action corresponding to the button on the selected concept. FIGS. 4B and 4C depict user interfaces which allow a user to modify or add concepts. According to an embodiment of the present invention, these user interfaces are invoked when the user selects “Add” button 406 or “Modify” button 408.

FIG. 4B depicts a simplified user interface 430 which allows users to add or modify concepts. A user may specify a new concept by entering the new concept name (or identifier) in box 432. If the user is modifying a pre-defined concept, the name of the concept is displayed in box 432. Box 434 allows the user to specify a short identifier for the concept. In order to save critical user interface real estate, the short concept identifier is displayed in area 206 while viewing the document as depicted in FIGS. 2A and 2B. Words, phrases, or other text patterns associated with the concept displayed in box 432 and which indicate discussion of the concept are displayed in a scrollable window 438. These text patterns indicate patterns which are used by the present invention to identify locations within the document which are relevant to the concept. The user may associate new text patterns with the concept by entering the text patterns in box 440 and then selecting “Add” button 442. The new text patterns are then added to the list displayed in window 438. A user may remove a text pattern by selecting the text pattern to be removed in window 438, and then selecting “Remove” button 446. A text pattern selected in window 438 is displayed in box 440. The user may amend the text pattern in box 440 and then select “Modify” button 444 to change the text pattern associated with the concept. The modified text pattern is then added to the list displayed in window 438.

User interface 430 also allows the user to configure the manner in which text identified in the document identified as being relevant to a concept will be annotated. For example, in an embodiment of the present invention which uses different colors to annotate concept-relevant items, user interface 430 provides options 436 which allow the user to define the color to be associated with a particular concept displayed in box 432. The user configured color is then used to annotate items related to the concept.

User interface 430 also may provide other options to be associated with the concept. These options may include a “Enabled” option 448 which permits the user to select whether or not the document contents are to be searched for items related to the concept, a “Public” option which permits the user to select whether or not information related to the concept may be shared with other applications or users, a “Meter” option 452 which permits the user to select whether or not the meter relevance indicator is activated, and a “Learn” option 454 which permits the user to select whether or not to automatically update the user profile information.

FIG. 4C depicts a more sophisticated user interface 460 for defining a user profile in accordance with an embodiment of the present invention. User interface 460 includes a first window 462 which displays a list of pre-defined concepts which have already been added to the user profile. A user may add a new concept by selecting concept add button 464. A user may modify the belief network as it pertains to the listed concept that is currently selected by selecting concept edit button 466. The user may delete a concept by selecting remove button 468.

If a concept has been selected for editing, its name appears in concept name box 470. The portion of the belief network pertaining to the selected concept is shown in a belief network display window 472. Belief network display window 472 shows the selected concept, the sub-concepts which have been defined as relating to the selected concept and the percentage values associated with each relationship. The user may add a sub-concept by selecting a sub-concept add button 474. The user may edit a sub-concept by selecting the sub-concept in belief network display window 472 and then selecting a sub-concept edit button 476. A sub-concept remove button 478 permits the user to delete a sub-concept from the belief network.

Selecting sub-concept add button 474 causes a sub-concept add window 480 to appear. Sub-concept add window 480 includes a sub-concept name box 482 for entering the name of a new sub-concept. A slider control 484 permits the user to select the percentage value that defines the probability of the selected concept appearing given that the newly selected sub-concept appears. A keyword list 486 lists the keywords, key phrases, and other text patterns associated with the concept and which indicate discussion of the sub-concept. The user may add to the list by selecting a keyword add button 488 which causes display of a dialog box (not shown) for entering the new keyword or key phrase. The user may delete a keyword, key phrase, or any text pattern by selecting it and then selecting a keyword delete button 490. Once a new sub-concept has been defined, the user may confirm the definition by selecting “OK” button 492. Selection of “Cancel” button 494 dismisses sub-concept add window 480 without affecting the belief network contents or structure. Selection of sub-concept edit button 476 causes display of a window similar to sub-concept add window 480 permitting redefinition of the selected sub-concept.

Background learning option 496 permits the user to select whether or not the present invention will automatically update the contents of the user profile based on information gathered by the present invention from the present or previous document searches. Web auto-fetch option 497 permits the user to select whether or not to enable an automatic web search process. When this web search process is enabled, whenever a particular keyword or key phrase is found frequently near where a defined concept is determined to be discussed, a web search tool such as AltaVista™ may be employed to look on the World Wide Web for documents containing the keyword or key phrase. A threshold slider control 498 is provided to enable the user to set a threshold relevance level for this auto-fetching process.

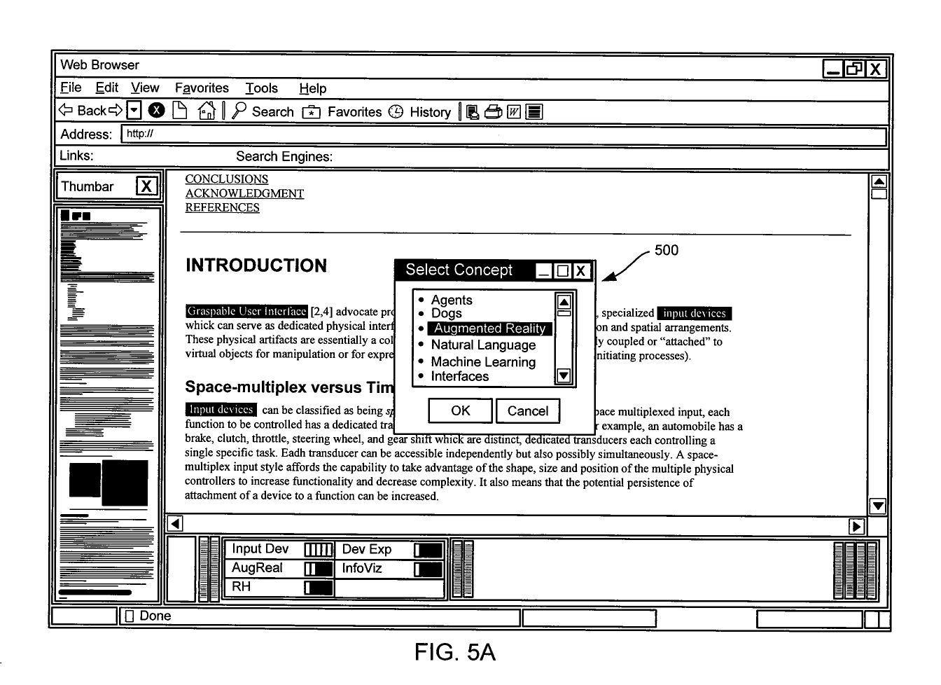

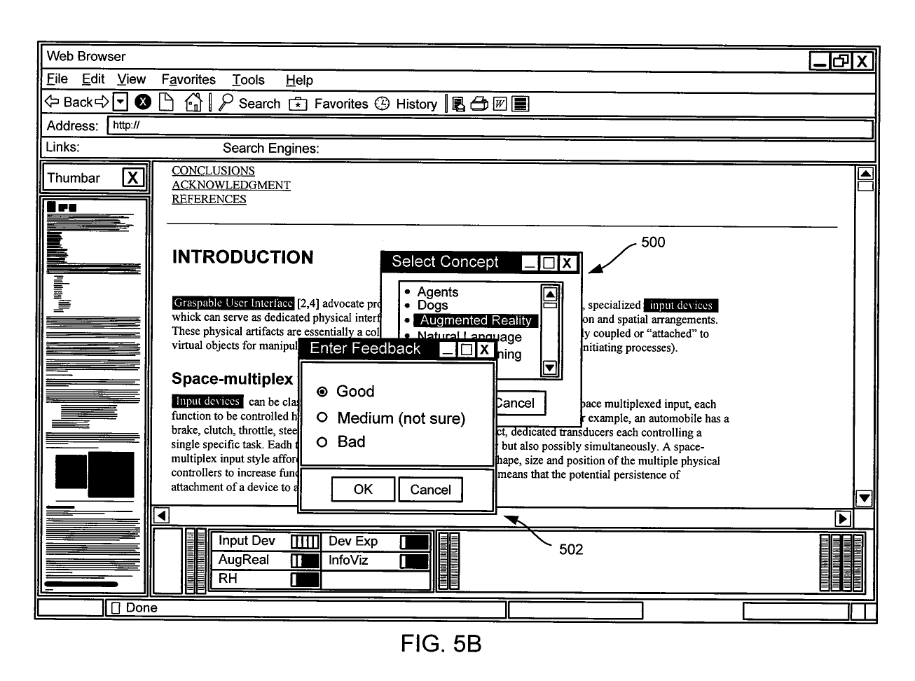

FIGS. 5A and 5B depict a user interface for providing feedback in accordance with one embodiment of the present invention. A user may select any text in first viewing area 202 and call up a first feedback window 500 listing a plurality of predefined concepts. The text may or may not have been previously identified by the annotation system as relevant. In first feedback window 500 shown in FIG. 5A, the user may indicate the concept to which the selected text is relevant. First feedback window 500 may not be necessary when adjusting the relevance level for a keyword or key phrase that is already a part of belief network 300. After the user has selected a concept in first feedback window 500, a second feedback window 502 (depicted in FIG. 5B) may be displayed for selecting the degree of relevance. According to a specific embodiment, second feedback window 502 in FIG. 5B provides three choices for level of relevance: good, medium (not sure), and bad. Alternatively, a slider control could be used to set the level of relevance. In a specific embodiment, the user selected phrase or word may be directly added to the list of text patterns associated with the concept. Alternatively, if the selected text is not already a keyword or key phrase associated with the concept in belief network 300, a new sub-concept may be added along with the associated new keyword or key phrase. If the selected text is already a keyword or key phrase, above, probability values within belief system 300 may be modified appropriately in response to this user feedback. According to alternate embodiments of the present invention, a user may associate a phrase or word with a concept, by selecting the phrase or word, and dragging and dropping the selected phrase or word onto a concept displayed in area 206.

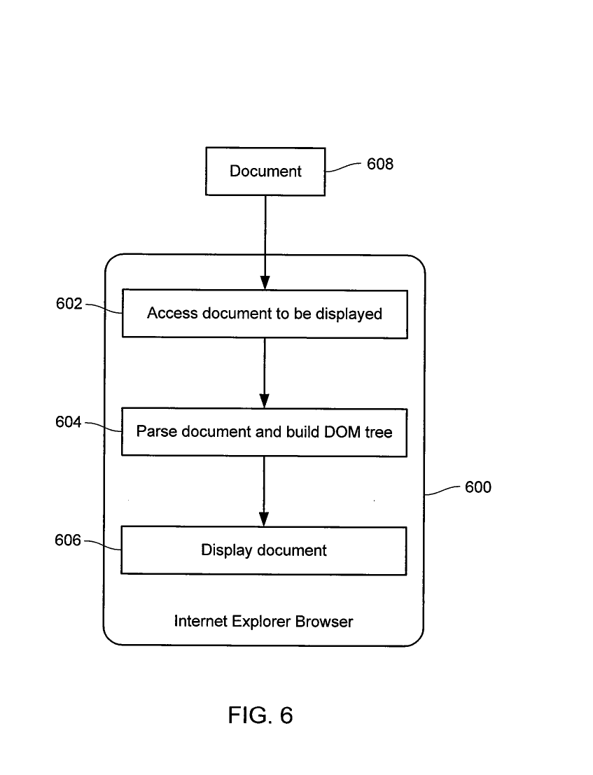

In order to understand the workings of the present invention, it is useful to understand how an IE browser displays documents to a user. FIG. 6 depicts processing performed by IE browser 600 for displaying a document to the user. The processing is generally initiated when IE browser 600 accesses a document 608 in electronic form to be displayed to the user (step 602). For the embodiment described below, it is assumed that document 608 is a Hypertext Markup Language (HTML) document. However, other documents in other formats, such as Postscript, Adobe PDF format, LaTeX, various word processing formats, various email formats, may also be displayed by the present invention. The document may also be embedded in a COM object which is received by IE browser 600. Document 608 may be stored locally on the computer system executing IE browser 600, or may be received from another device such as a copier, fax machine, scanner, etc. coupled to the computer system executing the browser, or may be received by IE browser 600 via a network such as the Internet, an intranet, and the like.

HTML document 608 accessed by IE browser 600 is then parsed to extract contents of the document (step 604). In a specific embodiment of IE browser 600, the parsing is performed by Microsoft's HTML (MSHTML) parsing and rendering engine component of IE browser 600. The MSHTML parser reads the contents of document 608 and extracts elements from the documents based on HTML tags contained in document 608. MSHTML then exposes the contents of HTML document 608 via the Dynamic HTML Object Model and the Document Object Model (DOM) which is built during step 404 based on the contents of HTML document 608.

The DOM is a platform- and language-neutral interface that permits scripts and external applications to access and update the content, structure, and styles of HTML document 608. The DOM tree, which is built by MSHTML, provides a model describing the contents of HTML document 608. The DOM tree also provides an interface for accessing and manipulating the contents, including objects, elements, text, etc., contained in HTML document 608. A node in a DOM tree is generally a reference to an element, an attribute, or a string of text contained in HTML document 608 and processed by IE browser 600. For more information on DOM and MSHTML, please refer to documentation provided by the Microsoft Developers Network (URL: msdn.microsoft.com), the entire contents of which are herein incorporated by reference for all purposes.

HTML document 608 is then forwarded to a display component of IE browser 600 which displays document 608 to the user (step 606).

As stated above, the present invention provides features for automatically annotating documents to locate concepts of interest to a particular user and for configuring and displaying a thumbnail image of the contents of a document. According to an embodiment, the present invention is embodied in one or more software modules which are executed by processor 14 depicted in FIG. 1. In a specific embodiment, the modules are executed by the computer system which executes IE browser 600. In alternate embodiments the modules may also be executed by other computer systems.

Several techniques may be used to integrate the present invention with Microsoft's Internet Explorer (IE) browser 600. According to a first technique, an application incorporating the present invention may be integrated with IE browser 600 via a web browser hosting interface. According to this technique, IE browser 600 is hosted or embedded within the application incorporating the present invention. According to a second technique, an application incorporating the present invention may be configured as a plug-in to IE browser 600. Functionality provided by the Microsoft Explorer Bar APIs may be used to implement an embodiment of the present invention according to the second technique. Details related to the MS Explorer Bar APIs are provided by the Microsoft Developers Network (URL: msdn.microsoft.com). In particular, please refer to “Creating Custom Explorer Bars, Tool Bands, and Desk Bands” (URL: http://msdn.microsoft.com/workshop/browser/ext/overview/Bands.asp), the entire contents of which are herein incorporated by reference for all purposes. Several other techniques known to those of ordinary skill in the art may also be used to integrate the present invention with IE browser 600. The embodiment of the present invention described in this application uses the second technique to integrate with IE browser 600.

Using either of the above-mentioned techniques, the present invention uses various application programming interfaces (APIs) provided by Microsoft to access and manipulate the information stored in the DOM tree in order to provide the annotation and thumbnail features. Information related to the document to be displayed, e.g. IE browser events information, location information, including dimension and coordinate information may be accessed by the present invention using the APIs.

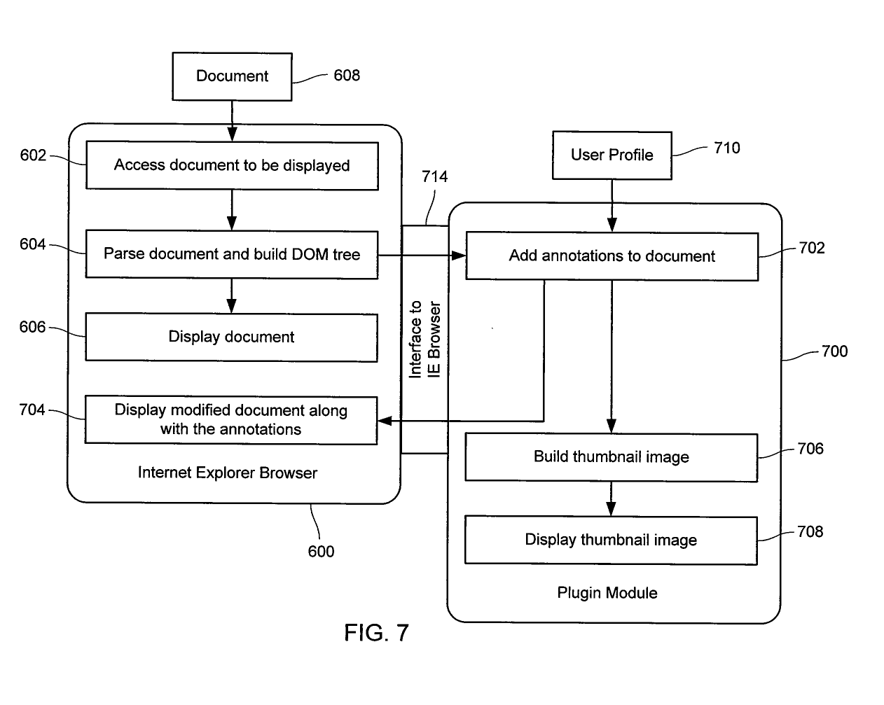

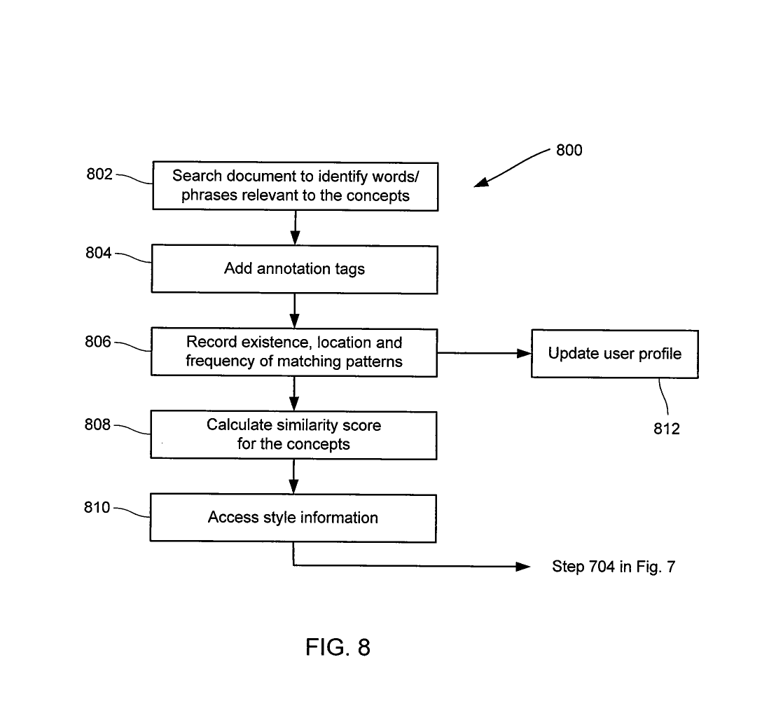

FIG. 7 depicts processing performed by an embodiment of the present invention for annotating HTML document 608 and for configuring and displaying a thumbnail image according to the teachings of the present invention. As shown in FIG. 7, processing is generally initiated when IE browser 600 accesses document 608 in electronic form to be displayed to the user (step 602). HTML document 608 is then parsed by IE browser 600 and a DOM tree is built to expose the contents of HTML document 608 (step 604). The original HTML document 608 is then displayed to the user by IE browser 600 (step 606). Details related to steps 602, 604, and 606 are described above.

According to the teachings of the present invention, annotations are then added to the contents of HTML document 608 (step 702). According to an embodiment, plug-in module 700 incorporating the present invention uses information exposed by the DOM tree built in step 604 and interfaces 714 provided by IE browser 600 to add the annotations. In order to add annotations to HTML document 608, plug-in module 700 searches HTML document 608 to identify words/phrases or text entities in document 608 which are relevant to the user-specified concepts and which are of interest to the user. The identification of the words/phrases/text entities is based on the text patterns associated with the concepts which may be stored in a user profile 710. According to a specific embodiment, the identification is accomplished by referring to a belief system such as system 300 depicted in FIG. 3. After the annotations have been added to document 608, the document along with the annotations inserted by module 700 is then forwarded to IE browser 600 which displays the modified HTML document and the annotations (step 704). In a specific embodiment, IE browser 600 overlays the originally displayed HTML document with the modified HTML document containing the annotations.

The present invention then builds a thumbnail image for HTML document 608 (step 706). In order to build the thumbnail image, module 700 extracts contents embedded in HTML document 608. The contents may include images, forms, text, multimedia content, various tags defined by the HTML standard, and the like. The forms may include URLs, text fields, input fields, lists, buttons, and other like information. The present invention uses the extracted information to build the thumbnail image. Annotations added to HTML document 608 in step 702 are also reflected in the thumbnail image. The thumbnail image is then displayed to the user (step 708). As part of step 708, a section of the thumbnail image is emphasized to correspond to the section of HTML document 608 displayed in first viewing area 202. Further details associated with steps 702, 704, 706, and 708 are provided below.

FIG. 8 depicts a simplified flowchart 800 depicting details related to processing performed by module 700 as part of step 702 in FIG. 7, for adding annotations to HTML document 608. As shown in FIG. 8, module 700 searches the contents of HTML document 608 to identify words/phrases or text entities contained in HTML document 608 which are relevant to one or more user-specified concepts (step 802). As stated above, the user-specified concepts and their corresponding text patterns may be stored in user profile 710. In this embodiment, module 700 reads user profile 710, determines the user-specified concepts of interest, identifies text patterns associated with the concepts of interest, and searches the contents of HTML document 608 to find locations of the text patterns relevant to the concepts.

For matching text patterns which are found in the contents of HTML document 608, the present invention inserts customized special HTML markup tags (or “annotation tags”) around the matching text patterns in HTML document 608 to identify locations of the found text patterns (step 804). The annotation tags identify locations within document 608 which are to be annotated when displayed to the user. The annotation tags also identify the concept to which a particular annotated text/phrase is relevant. This information is used to determine the manner in which the annotation will be displayed to the user.

For each relevant text pattern found in HTML document 608, module 700 records the existence, location, and frequency of the matching text patterns for each user-specified concept (step 806). In an embodiment of the present invention, for each concept, the location, frequency, and other information recorded in step 806 is stored in a data structure storing information for the concept, hereinafter referred to as a “concept data structure.” Each user-specified concept has a corresponding concept data structure storing information for the concept.

The present invention may also automatically update the contents of user profile 710 based on the results of the search performed in step 802 (step 812). This step is usually performed if the user has selected background learning option 496 depicted in FIG. 4C.

After entire HTML document 608 contents have been searched, a similarity score is calculated for each user-specified concept and HTML document 608 (step 808). The similarity score for a particular concept identifies the relevance of document 608 to the particular concept. The similarity score is displayed to the user using a relevance indicator, e.g. relevance indicator 210 depicted in FIG. 2A, when the document is displayed to the user. In a specific embodiment, the similarity score is calculated based on information stored in the concept data structure corresponding to the concept, including information related to the frequency and locations of the matching text patterns found in HTML document 608 for that particular concept.

The present invention then accesses information describing the style to be used for displaying the annotations added to document 608 (step 810). As described above, several styles may be used to display the annotations for the various concepts, e.g. using different colors for the different concepts, using bolded text, using underlined text, using text of a different font or type, using marginal annotations, using balloons, and the like. Generally, style information is configured for each user specified concept and determines the manner in which the annotation is displayed for the concept. In an embodiment of the present invention, the annotation style information for a concept is stored in the concept data structure storing information for that particular concept. In another embodiment of the present invention, the style information is stored in the modified HTML document.

The annotated HTML document, which includes the inserted annotation tags and optionally the style information, is then displayed to the user using IE browser 600 (step 704). The annotations are displayed using the style information associated with the concepts to which the annotated text is relevant.

According to an embodiment of the present invention, module 700 uses information related to HTML document 608 stored by the DOM tree to perform the steps depicted in FIG. 8. According to an embodiment, the present invention accesses the information stored in the DOM tree by accessing an IWebBrowser interface which provides access, via a pointer to the DOM tree, for HTML documents processed by IE browser 600. The present invention then searches the contents of HTML document 608, as exposed by the DOM tree, to identify locations of text patterns in HTML document 608 which match text patterns corresponding to one or more user-specific concepts of interest.

The present invention may use several techniques to perform the steps depicted in FIG. 8. According to a first technique, the present invention uses an IHTMLTxtRange interface. According to another technique, the present invention may use an IMarkupServices interface. Each of these techniques are discussed below in greater detail.

According to the first technique, an embodiment of the present invention uses the information stored in the DOM tree by accessing an IWebBrowser interface which provides access, via a pointer to the DOM tree, for HTML documents processed by IE browser 600. A pointer to an IHTMLDocument2 interface can be obtained from the IWebBrowser interface. From the IHTMLDocument2 interface, the present invention obtains a pointer to an IHTMLBodyElement interface, which is then used to obtain a pointer to an IHTMLTxtRange interface. The following code snippet shows how this may be accomplished according to an embodiment of the present invention:

```
//Declare variables
CComPtr<IDispatch> spDispActiveDoc;
CComPtr<IHTMLTxtRange> spHTMLTxtRange;
CComPtr<IHTMLElement> spHTMLElement;
iwebBrowser2->get_Document(&spDispActiveDoc);
CComQIPtr<IHTMLDocument2, &IID_IHTMLDocument2>
                  spHTMLDoc2 (spDispActiveDoc);
//Get pointer to IHTMLBodyElement interface
spHTMLDoc2->get_body(&spHTMLElement);
CComQIPtr<IHTMLBodyElement, &IID_IHTMLBodyElement>
                  spHTMLBodyElement (spHTMLElement);
//Get pointer to IHTMLTxtRange interface
spHTMLBodyElement->createTextRange(&spHTMLTxtRange);
```

The IWebBrowser2 interface enables applications to implement an instance of the WebBrowser control (ActiveX® control) or control an instance of the Microsoft Internet Explorer application (OLE Automation). The IWebBrowser2::get_Document method retrieves a pointer to the IDispatch interface of the Active Document object. The syntax for the IWebBrowser2::get_Document interface is as follows:

HRESULT get_Document(
IDispatch **ppDisp
);

where “ppDisp” is an address of an IDispatch variable that receives the pointer to the object's IDispatch interface. “HRESULT” returns an okay status if the operation was successful, a fail status if the operation failed, an invalid arguments status if one or more parameters are invalid, and “E_NOINTERFACE” if the interface is not supported.

When the active document is an HTML page, the IWebBrowser2::get_Document method provides access to the contents of the HTML document's object model. Specifically, it returns an IDispatch interface pointer to the HTMLDocument component object class (co-class). The HTMLDocument co-class is functionally equivalent to the DHTML document object used in HTML script. It supports all the properties and methods necessary to access the entire contents of the active HTML document (i.e. of document 608). Programs can retrieve the COM interfaces IHTMLDocument, IHTMLDocument2, and IHTMLDocument3 by calling QueryInterface on the IDispatch received from the IWebBrowser2::get_Document method. For more information about the IWebBrowser2 interface please refer to the documentation provided by the Microsoft Developers Network (URL: msdn.microsoft.com), the entire contents of which are herein incorporated by reference for all purposes.

The IHTMLDocument2 interface retrieves information about HTML document 608, and provides methods for examining and modifying the HTML elements and text within document 608. The IHTMLDocument2::get body method retrieves an interface pointer to the document's body object. The syntax for the IHTMLDocument2::get body method is as follows:
HRESULT IHTMLDocument2::get body(IHTMLElement**p);

where “p” is an address of a pointer to the IHTMLElement interface of the body object. “HRESULT” returns an okay status if the method was successful, or an error value otherwise. For more information about the IHTMLDocument2 interface please refer to the documentation provided by the Microsoft Developers Network (URL: msdn.microsoft.com), the entire contents of which are herein incorporated by reference for all purposes.

The IHTMLBodyElement interface provides access to the body element, and specifies the beginning and end of the document body. The IHTMLBodyElement::createTextRange method creates a TextRange object for an element of the document. The TextRange object represents text in an HTML element and may be used to retrieve and modify text in an element, to locate specific strings in the text, and to carry out commands that affect the appearance of the text. The syntax for the IHTMLBodyElement::createTextRange method is as follows:

HRESULT createTextRange(
IHTMLTxtRange **range
);

where “range” is an address of a pointer to an IHTMLTxtRange interface that receives a TextRange object if successful, or NULL otherwise. “HRESULT” returns an okay status if the method was successful, or an error value otherwise. The text range may be used to examine and modify the text within an object. For more information about the IHTMLBodyElement interface please refer to the documentation provided by the Microsoft Developers Network (URL: msdn.microsoft.com), the entire contents of which are herein incorporated by reference for all purposes.

The IHTMLTxtRange interface provides the ability to access a TextRange object which represents the text contained in each element contained in HTML document 608. The IHTMLTxtRange interface provides a “findtext” method to search the contents of HTML document 608 for text patterns matching the text patterns associated with the user-specified concepts of interest. The “findText” method searches for text in a given range, and positions the start and end points of the text range to encompass the matching string. The syntax for the IHTMLTxtRange:.findText method is as follows:

| HRESULT findText ( | |
|---|---|
| BSTR | String, |
| long | count, |
| long | Flags, |

VARIANT_BOOL *Success
);

where “String” specifies the text to find, “count” is a long integer that receives the count, “Flags” is a long integer that receives the search flags, and “Success” contains the address of a variable that receives TRUE if the text is found, or FALSE if not found.

As previously described, upon finding a matching text pattern in HTML document 608, the present invention then places customized special annotation tags around the found text pattern (step 804 in FIG. 8). This is accomplished using a “pasteHTML” method provided by the IHTMLTxtRange interface. The “pasteHTML” method pastes HTML text specified in the method call into the given text range. The pasted text completely replaces any previous text and HTML elements in the range. The syntax for the IHTMLTxtRange::pasteHTML method is as follows:

HRESULT pasteHTML (
BSTR html;
);

where “html” is a string that specifies the HTML text to paste.

According to an embodiment of the present invention, the “html” string comprises the matching text pattern surrounded by the special annotation tags. For example, if text “a relevant string” found in HTML document 608 is considered relevant to a particular concept, the text may be replaced by “<Annotation tag> a relevant string</Annotation tag>” where the <Annotation tag> tags pasted around the found pattern identify the boundaries of the annotation. The annotation tags which are pasted around the found text pattern have special meaning in that they identify locations within HTML document 608 which are to be annotated when displayed to the user. The annotation tags also identify the concept to which the particular annotation is relevant and control the manner in which the annotated text pattern will be displayed to the user.

Accordingly, by using the “findtext” and “pasteHTML” methods, the present invention may iterate through HTML document 608, find the locations of text patterns matching patterns corresponding to the user-specific concepts, and surround the matching patterns with special annotation tags. As described above, the present invention then records the existence, location, and frequency of matching text patterns found in HTML document 608 for each user-specified concept in a concept data structure storing information for the concept (step 806 in FIG. 8). After the entire contents of HTML document 608 have been searched, a similarity score is calculated for each concept of interest based on the information stored in the concept data structure corresponding to the concept of interest (step 808 in FIG. 8). In an embodiment of the present invention, the similarity score is based on the frequency and locations of the matching text patterns found in HTML document 608 for that particular concept. The style information for the annotations is then accessed and the modified HTML document, including the annotations, is then displayed to the user.

A simplified high-level algorithm for annotating documents using the IHTMLTxtRange interface is as follows:

```
For each User-specified concept of interest (Cᵢ)
{
      For each text pattern Pᵢⱼ for concept Cᵢ
      {
            For all instances of text pattern Pᵢⱼ found in the document
            (using findText(Pᵢⱼ)), replace the found text pattern with the
            text pattern surrounded by annotation tags ( using
            pasteHTML(Pᵢⱼ + annotation tags))
      }
      Record frequency and location of Pᵢⱼ found in the document;
}
Compute similarity score for each Cᵢ based on locations and frequency of
matching text patterns corresponding to Cᵢ and stored in the concept data
structure for Cᵢ.
```

According to a second technique, an embodiment of the present invention searches the contents of HTML document 608 using services provided by the IMarkupServices interface. Like the IHTMLTxtRange interface, the IMarkupServices interface provides methods for programmatically accessing and manipulating contents of HTML document 608 as exposed by the DOM tree. The present invention instantiates an IMarkupServices object using services provided by the IMarkupServices interface. The IMarkupServices interface works in conjunction with an IMarkupContainer interface and an IMarkupPointer interface. The following code snippet shows how an IMarkupServices interface and an IMarkupContainer interface maybe instantiated according to an embodiment of the present invention:

```
CComPtr<IMarkupServices> markupServices;
CComPtr<IMarkupContainer> markupContainer;
spHTMLDoc2->QueryInterface(IID_IMarkupServices,
                    (LPVOID*)&markupServices);
spHTMLDoc2->QueryInterface(IID_IMarkupContainer,
                    (LPVOID*)&markupContainer);
```

In order to correlate text with the elements extracted by the MSHTML parser from HTML document 608, an IMarkupContainer object is created from the IMarkupServices object using services provided by the IMarkupServices interface. The IMarkupContainer object represents the organization of HTML elements in HTML document 608. An IMarkupContainer object may be created using an IMarkupServices::CreateMarkupContainer method which creates an instance of the IMarkupContainer object. The syntax for the IMarkupServices::CreateMarkupContainer method is as follows:

HRESULT CreateMarkupContainer(
IMarkupContainer **ppMarkupContainer;
);

where “ppMarkupContainer” contains the address of a pointer to an IMarkupContainer interface that returns the newly created object.

An IMarkupPointer pointer object is then instantiated using services provided by the IMarkupPointer interface to step through HTML document 608 contents. An IMarkupPointer object may be created using an IMarkupServices::CreateMarkupPointer method which creates an instance of the IMarkupPointer object. The syntax for the IMarkupServices::CreateMarkupPointer method is as follows:

HRESULT CreateMarkupPointer (
IMarkupPointer **ppMarkupPointer;
);

where “ppMarkupPointer” contains the address of a pointer to an IMarkupPointer interface that returns the newly created object.

The IMarkupPointer specifies a position within HTML document 608. For example, if HTML document 608 contained the following text:
I<B>li[p1]ke</B> to fly.
   the position of the IMarkupPointer is denoted by the [p1] pointer. There can be multiple IMarkupPointers referencing a particular HTML document.

The IMarkupPointer interface provides a “FindText” method which searches for the specified text from the pointer's current position to another IMarkupPointer's position within HTML document 608. The syntax for the IMarkupPointer::FindText method is as follows:

```
HRESULT FindText (
      OLECHAR *pchFindText,
      DWORD dwFlags,
      IMarkupPointer *pIEndMatch,
      IMarkupPointer *pIEndSearch
);
```

where “pchFindText” contains the address of an OLECHAR structure that specifies the byte string to find, “dwFlags” is a reserved field, “pIEndMatch” contains the address of an IMarkupPointer interface that specifies the end point of the match operation, and “pIEndSearch” contains the address of an IMarkupPointer interface that specifies the end point of the search. Thus, the “FindText” function requires a text string to search for and a second pointer such that if the text string is located in HTML document 608, the first pointer calling the “FindText” method will point to the beginning of the text string and the second pointer will point to the end of the text string. Accordingly, two IMarkupPointer objects are created to step through the contents of HTML document 608.

For example, the following code snippet shows how IMarkupPointers may be used to find a exemplary string “mystring” in HTML document 608.

//Instantiate IMarkupPointers
CComPtr<IMarkupPointer> tmpPtr1, tmpPtr2, endPtr;
//Instantiate an IMarkupServices object
IMarkupServices markupServices;
markupServices->CreateMarkupPointer(&tmpPtr1);
markupServices->CreateMarkupPointer(&tmpPtr2);
markupServices->CreateMarkupPointer(&endPtr);
//Call method “FindText”
tmpPtr1->FindText(pToken, 0, tmpPtr2, endPtr);

where “pToken” contains the string to be found (i.e. points to “mystring”), “tmpPtr2” contains the end point of the match operation, and “endPtr” specifies the end point of the search. For example, the position of pointers tmpPrt1 and tmpPtr2 after a call to “FindText” can be shown as follows:
“ . . . the location of [tmpPtr1]mystring[tmpPtr2] in the . . . ”

Once a matching string is located, a new HTML element can be inserted to replace the matching search string at the location indicated by the first and second pointers. This can be accomplished using the following code snippet according to an embodiment of the present invention:

IHTMLElement *element;
markupServices->CreateElement(TAGID_SPAN, (unsigned short*)tagstr;
&element);
markupServices->InsertElement(element, tmpPtr1, tmpPtr2);

In this case, the “tagstr” may contain information to be inserted into the tag. e.g. “class=rhtopic_{—}12”, which identifies the concept to which the found text pattern is relevant. Using the “mystring” example shown above, the text after insertion of the tags may be shown as follows:
“ . . . the location of <SPAN class=rhtopic_{—}12>mystring</SPAN> in the . . . ”
   As with the IHTMLTxtRange method, the present invention replaces the contents between the pointers with the matching string surrounded by special annotation tags which convey information which is used to display the matching text pattern to the user when HTML document 608 is displayed to the user.

As described above, the present invention then records the existence, location, and frequency of matching text patterns found in HTML document 608 for each user-specified concept in a concept data structure storing information for the concept (step 806 in FIG. 8). After the entire HTML document has been searched, a similarity score is calculated for each concept of interest based on information stored in the concept data structure corresponding to the concept of interest (step 808 in FIG. 8). In an embodiment of the present invention, the similarity score is based on the frequency and locations of the matching text patterns found in HTML document 608 for that particular concept. The style information for the annotations is then accessed and the modified HTML document, including the annotations, is then displayed to the user.

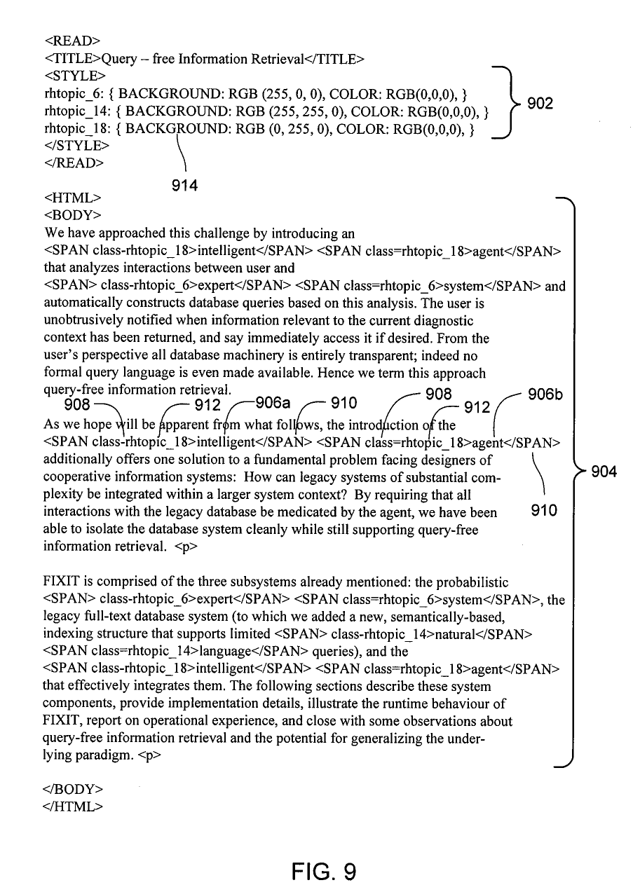

FIG. 9 depicts a portion of a modified HTML document which has been processed in accordance with one embodiment of the present invention. The modified HTML document includes a first section 902 (also called the “style sheet” for the document) which stores style information which is used for displaying the annotations to the user. As previously stated, the style information may also be stored in concept data structures. The following code snippet shows how the style information (also called “style rules”) may be inserted into the HTML document according to an embodiment of the present invention:

```
CComPtr<IHTMLStyleSheetsCollection> spStyles;
int len=0;
// Initialize string “styleString” containing the style information to
// ″SPAN.rhtopic_18 { background: RGB(0,255,0); color: RGB(0,0,0); }″
_bstr_t styleString(″SPAN.rhtopic_18 { background: RGB(0,255,0);
            color: RGB(0,0,0); }″);
// get the style rule collection from the document
m_pHTMLDoc2->get_styleSheets(&spStyles);
spStyles->get_length(&len);
if (len == 0 ) { //style sheet does not exist for the document
    // we'll use this variable to represent the style sheet for this document
    CComPtr<IHTMLStyleSheet> spTempHTMLSSheet;
    // spHTMLDoc2 is the IHTMLDocument2 pointer
    m_pHTMLDoc2->createStyleSheet(NULL, 0, &sp
    TempHTMLSSheet);
  // this copies the style rule into the style sheet, thus incorporating it into
    the DOM spTempHTMLSSheet->put_cssText(styleString.copy( ));
}
else { //style sheet already exits for the document
    COleVariant VarIndex((long)0);
    VARIANT VarRet;
    VariantInit(&VarRet);
    pStyles->item(&VarIndex, & VarRet);
    CComQIPtr<IHTMLStyleSheet, &IID_IHTMLStyleSheet>
            spHTMLStyleSheet(VarRet.pdispVal);
    VarRet.pdispVal->Release( );
    if (spHTMLStyleSheet) {
        BSTR existingRules;
        // get the existing style rules and put them into “existingRules”
        spHTMLStyleSheet->get_cssText(&existingRules);
        // concatenate the new rules with existing rules
        styleString+= existingRules;
        // insert the new collection of rules into the style sheet
        hr = spHTMLStyleSheet->put_cssText(styleString.copy( ));
    }
}
```

According to the above code snippet, styles may be inserted into the HTML document. It should be apparent that variable “styleString” may contain information for one (as shown in the above code snippet) or more style rules. The present invention first determines if the HTML document already includes a style sheet 902. If a style sheet already does not exist in the document, the present invention creates a style sheet for the document and then adds the style rules to the style sheet (implemented by the code within the “if” loop in the above code snippet). If the document already includes a style sheet, then the present invention appends the new style rules to the existing style sheet (implemented by the code within the “else” loop in the above code snippet).

A second section 904 contains the body of HTML document 608. As shown in FIG. 9, text patterns found in body 904 which are relevant to one or more concepts are surrounded by annotation tags inserted by the present invention during step 804 of FIG. 8. For example, the words “intelligent” 906a and “agent” 906b are preceded by annotation tags 908 and followed by annotation tags 910. Each annotation tag 908 marks the start of the annotation section and tag 910 marks the end of the annotation section. Accordingly, tags 908 and 910 mark the boundaries of the text to be annotated. Annotation tag 908 also contains information identifying the user concept to which text 906a and 906b is relevant. For example, tag 908 in FIG. 9 indicates that the words “intelligent” 906a and “agent” 906b are relevant to concept identified by identifier “rhtopic_{—}18” 912. This information is used by IE browser 600 to locate sections of HTML document 608 which are to be annotated when displayed to the user, and to determine the manner in which the annotation is to be displayed. For example, for text pattern 906, IE browser 600 determines that the text is relevant to concept identifier “rhtopic_{—}18” 912 indicated by tag 908. IE browser then refers to style section 902 to determine the style information configured for “rhtopic_{—}18.” After determining that style 914 corresponds to “rhtopic_{—}18,” IE browser 600 displays the annotation using style 914. It should be apparent that a particular word may be relevant to more than one concept.

After determining the annotations, an embodiment of the present invention then proceeds to build and display a thumbnail image for the document as per steps 706 and 708 in FIG. 7. It should however be apparent that the process of building and displaying the thumbnail image may be performed before or in parallel to the process of configuring and displaying the annotations.

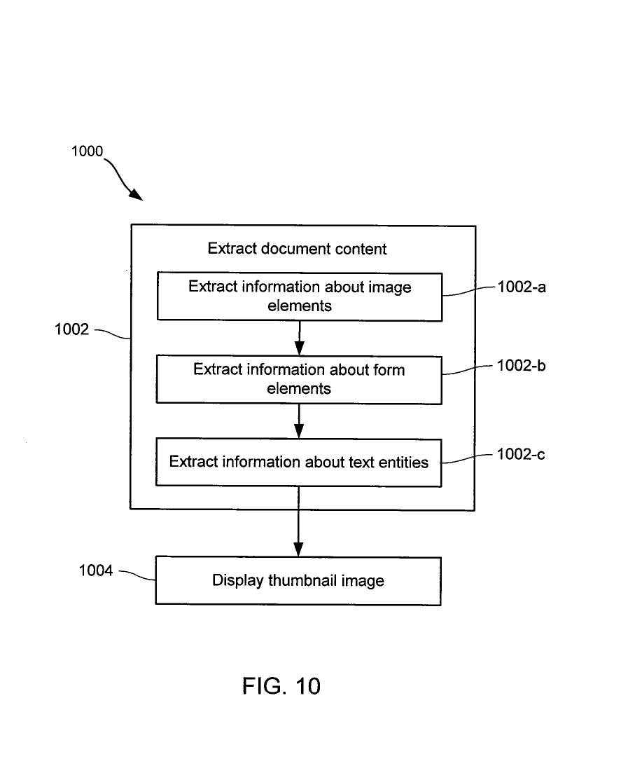

FIG. 10 depicts a simplified flowchart 1000 depicting processing performed by an embodiment of the present invention as part of steps 706 and 708 in FIG. 7. In order to build the thumbnail image, module 700 extracts the contents contained in HTML document 608 (step 1002). As previously described, the contents may include text and elements such as images, forms, multimedia content, various tags defined by the HTML standard, and the like. The forms may include URLs, text fields, input fields, lists, buttons, and other like information.

As part of the extraction process, the present invention determines information about the elements and text embedded in HTML document 608. This information may include URL information about the element or text, location of the text or element within HTML document 608, information about the dimensions of the element or text, size of the element or text, page coordinates of the element or text, and other like information. The extraction step 1002 produces a list of elements contained in HTML document 608 which are to be displayed in the thumbnail image.

By building a thumbnail image using the extracted elements and text, the present invention is capable of dynamically updating the thumbnail image contents when one or more elements of HTML document 608 are modified/manipulated. The thumbnail according to the teachings of the present invention thus comprises “dynamic” entities which make the thumbnail contents highly configurable. This is substantially different from the “static” nature of thumbnails provided by prior art techniques such as thumbnails provided by Adobe's Acrobat related products.

Various interfaces and methods may be used to extract information related to the elements and the text from the DOM tree. For example, an IHTMLDocument2 interface which may be accessed from the IWebBrowser interface provides a direct interface to the DOM tree. Information associated with individual elements of HTML document 608 may be extracted by using the IHTMLElement and IHTMLTxtRange interfaces, an IHTMLElement2 interface accessed from the IHTMLElement interface, an IHTMLElementCollection accessed from the IHTMLDocument2 interface, and other like interfaces. Further details regarding extraction of information for the elements and text contained in HTML document 608 are provided below.

According to an embodiment, as shown in FIG. 10, as part of step 1002, the present invention extracts information related to images (step 1002-a), forms (step 1002-b), and text (step 1002-c) embedded in HTML document 608 contents. It should however be apparent that information related to other types of elements may also be extracted by alternate embodiments of the present invention. It should further be apparent that the elements and text may be extracted in any order. Accordingly, the extraction order depicted in FIG. 10 and described below is merely indicative of an embodiment of the present invention and does not limit the scope of the present invention as recited in the claims.

The information extracted by the present invention for each element of HTML document 608 is stored in a special data structure (hereinafter referred to as the “thumbnail object” for sake of description) corresponding to the element. A thumbnail object may store information associated with an image element, a form element, a word entity, a hypertext link, a table entry, and the like. The information stored in the thumbnail objects is used for constructing the thumbnail image. A collection of thumbnail objects thus represents the various elements and text displayed in the thumbnail image.

In a specific embodiment of the present invention, image elements included in HTML document 608 may be obtained using the IHTMLDocument2 pointer obtained during search step 802 in FIG. 8. The IHTMLDocument2 interface, which is accessed from the IWebBrowser interface, provides a “get_images” method which obtains a pointer to an IHTMLElementCollection interface. The syntax for IHTMLDocument2::get_images method is as follows:

HRESULT get_images (
IHTMLElementCollection **p
);

where “p” contains the address of a pointer to the IHTMLElementCollection interface of the images collection. The IHTMLElementCollection interface provides access to a collection of image elements contained in HTML document 608. The images are in the same order as they appear in the document.

For example, the following code snippet shows the above described process:

//Instantiate an IHTMLDocument2 object
IHTMLDocument2 ihtmlDocument2;
//Instantiate an IHTMLElementCollection object
CComPtr<IHTMLElementCollection> allImages;
. . .
//Call method “get_images”
ihtmlDocument2->get_images(&allImages);

In the above code snippet, the call to method “get_images” instantiates/initializes the “allImages” variable with IHTMLElement objects representing images contained in HTML document 608. By iterating through the collection of image elements, the present invention may then access each individual IHTMLImgElement of the collection which represents an individual image, and get information specific to the individual image element. The IHTMLImgElement interface provides access to some of the properties and methods supported by the image elements.

For each image element, the present invention may determine URL information associated with the image. The URL information may be obtained using the IHTMLImgElement::get_href method which retrieves a URL for the image object. The syntax for the IHTMLImgElement::get_href method is as follows:
HRESULT IHTMLImgElement::get_href(BSTR *p);
   where “p” is a pointer to a string that receives the URL information. The URL information allows the present invention to download the image corresponding to the image element from the site indicated by the URL. Alternatively, the image data may be obtained from the user's cache. The URL may be converted to a special filename which is used by the present invention to locate the image in the browser's cache directory. In a specific embodiment of the present invention, the “RetrieveUrlCacheEntryFile” function may be used to convert an URL to a proper filename. The image file may be loaded by the present invention from the cache and stored in an internal data structure or class. The URL information may be stored in a thumbnail object corresponding to the image element.

The present invention also determines dimension and coordinate information for each image element. The dimension information may include information about the width of the image element, the height of the image element, and the like. Coordinate information may include information about the x-y coordinates of the image element, and other like coordinate information. In order to extract the coordinate and dimension information for the image element, each IHTMLImgElement object representing the image element in the IHTMLElementCollection is cast to an IHTMLElement2 object as shown below. The IHTMLElement2 object allows access to properties and methods that are common to all element objects.

| | |
|---|---|
| IHTMLImgElement | element; //Instantiate an IHTMLImgElement object |
| IHTMLElement2 | element2; //Instantiate an IHTMLElement object |

. . .
//Cast to an IHTMLElement2 object
element2 = (IHTMLElement2) element;

The IHTMLElement2 object is then cast to an IHTMLRect object which provides the coordinate and dimension properties of the image element. For example:

IHTMLRect rect;
//Cast to an IHTMLRect object
rect = (IHTMLRect) element2;

The coordinate and dimension information for an image element is stored in the thumbnail object corresponding to the image element.

Information for form elements may be extracted in a manner similar to image elements. In a specific embodiment of the present invention, form elements contained in HTML document 608 may be obtained using the IHTMLDocument2 interface obtained during step 802 in FIG. 8. The IHTMLDocument2 interface, which is accessed from the IWebBrowser interface, provides a “get_forms” method which obtains a pointer to an IHTMLElementCollection interface. The syntax for IHTMLDocument2::get_forms method is as follows:

HRESULT get_forms (
IHTMLElementCollection **p
);

where “p” contains the address of a pointer to the IHTMLElementCollection interface which contains all the form objects in HTML document 608. The IHTMLElementCollection interface provides access to a collection of FORM objects contained in HTML document 608. The form objects are in the same order as they appear in the document.

For example, the following code snippet shows the above described process:

//Instantiate an IHTMLDocument2 object
IHTMLDocument2 ihtmlDocument2;
//Instantiate an IHTMLElementCollection object
CComPtr<IHTMLElementCollection> allForms;
. . .
//Call method “get_forms”
ihtmlDocument2->get_forms(&allForms);

In the above code snippet, the call to method “get_forms” instantiates “allForms” with IHTMLElement objects representing form objects contained in HTML document 608.

By iterating through the collection of form elements, the present invention may then access each individual IHTMLFormElement of the collection which represents a form object, and get information specific to the individual form element. The IHTMLFormElement interface provides access to properties of the form elements. These properties enable the present invention to determine if the form element is a button, or an input box, or any other type of form element.

The present invention also determines dimension and coordinate information for each form element. The dimension information may include information about the width of the form element, the height of the form element, and the like. Coordinate information may include information about the x-y coordinates of the form element, and other like coordinate information. In order to extract the coordinate and dimension information for the form element, each IHTMLFormElement object representing the form element in the IHTMLElementCollection is cast to an IHTMLElement2 object as shown below. The IHTMLElement2 object allows access to properties and methods that are common to all element objects.

IHTMLFormElement element; //Instantiate an IHTMLImgElement object
IHTMLElement2 element2; //Instantiate an IHTMLElement object
. . .
//Cast to an IHTMLElement2 object
element2 = (IHTMLElement2) element;

The IHTMLElement2 object is then cast to an IHTMLRect object which provides the coordinate and dimension properties of the form element. For example:

IHTMLRect rect;
//Cast to an IHTMLRect object
rect = (IHTMLRect) element2;

The coordinate and dimension information for a form element is stored in the thumbnail object corresponding to the form element.

After extracting information about the image (step 1002-a) and form elements (step 1002-b) contained in HTML document 608, the present invention extracts information associated with the text entities contained in HTML document 608 (step 1002-c). A text entity may include words and punctuation. In a specific embodiment of the present invention this may be accomplished by using the IHTMLTxtRange object obtained during the searching step, and using that object to step through the text contained in HTML document 608, one word at a time.

The IHTMLTxtRange interface provides a “get_text” method which may be used to iterate through the text entities contained in the HTML document. By setting up a loop, the “get_text” method may be used to obtain a pointer to individual text entities, including words and punctuation, contained in HTML document 608. The syntax for the IHTMLTxtRange::get_text method is as follows:

HRESULT get_text (
BSTR *p;
);

where “p” contains the address of a variable that receives the text.

Using the results obtained from the IHTMLTxtRange::get_text method, the present invention may determine dimension and coordinate information for the text entities using the IHTMLTextRangeMetrics interface. The IHTMLTextRangeMetrics interface which exposes positional information, including dimension and coordinate information, about each text entity. The IHTMLTextRangeMetrics interface may also be used to extract information about the manner in which the text entity is being used in HTML document 608, e.g. as part of a hypertext link, as part of a concept of interest, the color of the word, if the word contains special formatting characters such as bolding, underlining, or italicizing, if the word is part of a text pattern corresponding to a concept of interest, and other like information. Information collected for each word entity is stored in a thumbnail object corresponding to the word entity.

As described above, as part of extracting information for word entities, the present invention also determines if the word is part of a text pattern relevant to one or more user-specified concepts of interest. In an embodiment of the present invention, this is determined by checking if the word is contained in a text pattern which is surrounded by special annotation tags inserted during step 804 in FIG. 8. If a particular word entity is determined to be part of a matching text pattern for a particular concept of interest, then a pointer to the concept data structure of the particular concept is stored in the thumbnail object for the particular word entity. This correlation between the word entity thumbnail object and the concept data structure allows the thumbnail object to access information, e.g. style information, stored for the concept in the concept data structure. Using this correlation, word entities in the thumbnail image can be displayed using the same style information used for displaying the corresponding word entities in first viewing are 202. For example, if words related to a “CONCEPT_{—}1” are displayed in “red” in first viewing area 202, the corresponding words will also be displayed in “red” in the thumbnail image.

Further, the correlation also enables a text entity thumbnail object to be automatically notified of changes made to information stored in the concept data structure. These changes may include changes to the style information which indicates the manner in which the annotation is displayed to the user. Accordingly, if the annotation style of a concept is changed, the corresponding text entities in the thumbnail image will automatically and dynamically updated to reflect the change. For example, if word entities related to “CONCEPT_{—}1” are now to be displayed in “green” rather than “red” in first viewing area 202, the corresponding word entities in the thumbnail image will also be automatically changed to show the annotation in green.

Referring back to FIG. 10, after information about the contents of HTML document 608 has been extracted, the thumbnail is then configured and displayed to the user based on information contained in the thumbnail objects for the various contents of HTML document 608 (step 1004). In a specific embodiment, the present invention displays the contents of the thumbnail by iterating through the collection of thumbnail objects generated in step 1002, and displaying the objects.

For each element or text entity, the present invention uses the dimension and coordinate information stored in the thumbnail objects for the element or text entity to determine the position of the element or text entity in the thumbnail image. For each thumbnail object, the present invention divides the dimension and coordinate information stored in the thumbnail object by a reduction ratio (or aspect ratio) to produce new coordinates for displaying the element corresponding to the thumbnail object. For example, if the aspect ratio is 6, i.e. the thumbnail 214 is to be ⅙th the size of the document displayed in first viewing area 202, then the x-y coordinates, width, and height information stored in each thumbnail element object are divided by 6, such that the elements drawn in thumbnail 214 are ⅙th the size of the corresponding objects displayed in first viewing area 202.

Each element or text entity is displayed in a style and manner as indicated by the information stored in or associated with the thumbnail object corresponding to the particular element or text entity. Since the thumbnail objects may store pointers to concept data structures, text entities matching patterns associated with the concepts are displayed in a similar style in the thumbnail image as displayed in first viewing area 202. For example, as discussed above, if words related to a “CONCEPT_{—}1” are displayed in “red” in first viewing area 202, the corresponding words will also be displayed in “red” in the thumbnail image. Further, if the user changes the style for displaying annotations for a concept, the changes are dynamically and automatically reflected in the thumbnail image. For example, if the user indicates that words related to CONCEPT_{—}1 are to be displayed in green rather than red, the color change is automatically and dynamically reflected in thumbnail image 214.

As part of step 1004, the present invention also determines the section of the document which is displayed in first viewing area 202. The present invention then emphasizes an area of thumbnail image 214 which corresponds to the section of the document displayed in first viewing area 202.

The contents of the thumbnail may be displayed after all the thumbnail element objects have been generated i.e. after information for the entire HTML document has been extracted, or alternatively may be displayed while information from HTML document 608 is being processed. It should be apparent that various other techniques for displaying the contents of the thumbnail are also within the scope of the present invention.

Although specific embodiments of the invention have been described, various modifications, alterations, alternative constructions, and equivalents are also encompassed within the scope of the invention. For example, any probabilistic inference method may be substituted for a Bayesian belief network. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps. Further information about the various interfaces and methods discussed above can be found at URL “msdn.microsoft.com,” the entire contents of which are herein incorporated by reference for all purposes. Further, the entire contents of the Microsoft Developers Network (URL: msdn.microsoft.com) are herein incorporated by reference for all purposes.

Further, while the present invention has been described using a particular combination of hardware and software, it should be recognized that other combinations of hardware and software are also within the scope of the present invention. The present invention may be implemented only in hardware or only in software or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A computer-implemented method of displaying a document using a browser, the method comprising:
accessing the document;
searching the document to identify text patterns in the document which are relevant to a plurality of concepts;
marking locations of the text patterns in the document; and
displaying the document using the browser such that the text patterns in the document which are relevant to the plurality of concepts are annotated.
